(19) United States
(12) Patent Application Publication
(10) Pub. No.: US 2021/0124041 A1
(43) Pub. Date: Apr. 29, 2021

(54) METHOD AND DEVICE FOR ASCERTAINING AN INSTALLATION ANGLE BETWEEN A ROADWAY ON WHICH A VEHICLE TRAVELS AND A DETECTION DIRECTION OF A MEASUREMENT OR RADAR SENSOR

(71) Applicant: JENOPTIK ROBOT GMBH, Monheim (DE)

(72) Inventors: Dima PROEFROCK, Hamburg (DE); Michael LEHNING, Hildesheim (DE); Andre PAPPENDORF, Langenfeld (DE)

(73) Assignee: JENOPTIK ROBOT GMBH, Monheim (DE)

(21) Appl. No.: 16/766,352

(22) PCT Filed: Nov. 21, 2018
(86) PCT No.: PCT/EP2018/082023

§ 371 Date: May 22, 2020

(30) Foreign Application Priority Data
Nov. 24, 2017 (DE) 10 2017 221 034.6

(51) Int. Cl. G01S 13/92; G01S 13/931

(52) U.S. Cl. CPC G01S 13/92; G01S 13/931; G01S 2013/9321; G01S 2013/9329; G01S 2013/9327

(57) ABSTRACT

The invention relates to a method (500) for ascertaining an installation angle (α_{Install}) between a roadway (170) on which a vehicle (100) travels and a detection direction (122) of a measurement or radar sensor (105). The method (500) has a step (510) of reading a plurality of reflection signals (125), each of which represents a measurement or radar beam (120) which has been emitted by a transmission unit (115) of the measurement or radar sensor (105) and each of which has been reflected on a different reflective section (130) of the vehicle (100). The reflection signals (125) have movement information on a movement direction of the vehicle (100) reflective section (130) on which the measurement or radar beam (120) has been reflected, and/or the reflection signals (125) have position information that represents the position (420) of the vehicle (100) reflective section (130) on which the measurement or radar beam (120) has been reflected. The method (500) additionally has a step (520) of detecting a movement direction component (v₀) of the vehicle (100) reflective section (130) movement directions represented by the movement information from the plurality of reflection signals (125), wherein for said component all of the vehicle (100) reflective sections (130) are carrying out the same movement, and/or detecting a movement direction component (v₀) for which the vehicle (100) reflective section (130) positions (420) represented by the position information are mapped at the same point in time while assuming the movement according to the movement direction component (v₀) and form a shape at said point in time in a two-dimensional display, said shape having the greatest similarity to an L-shape (410). The method (500) lastly has a step (530) of determining the installation angle (α_{Install}) using the detected movement direction component (v₀).

This nonprovisional application is a National Stage of International Application No. PCT/EP2018/082023, which was filed on Nov. 21, 2018, and which claims priority to German Patent Application No. 10 2017 221 034.6, which was filed in Germany on Nov. 24, 2017, and which are both herein incorporated by reference.

### BACKGROUND OF THE INVENTION

### Field of the Invention

The concept presented here concerns a method and a device for ascertaining an installation angle between a roadway on which a vehicle travels and a detection direction of a measurement or radar sensor as claimed in the main claims.

### Description of the Background Art

In order to be able to penalize traffic infringements, in particular infringements of a maximum speed of vehicles in road traffic, highly accurate and hence legally acceptable measurement results are necessary. Often, such measurement results are generated by radar systems which emit a radar signal, receive a signal reflected by the vehicle to be measured as a reflection signal, and evaluate this. The problem here however is that, if the detection direction of the radar sensor, or more precisely the detection direction of the radar sensor for the reflected signal in relation to the movement direction of the vehicle on the roadway, is not known sufficiently precisely, measurement errors may occur which in some cases may mean that the measurement result is no longer legally acceptable. To this extent, it is of great importance to know the precise installation angle between a roadway on which a vehicle travels and a detection direction of the radar sensor, in order to be able to obtain a highly precise measurement result in knowledge of this installation angle.

### SUMMARY OF THE INVENTION

In this context, the object of the present invention is to create an improved possibility for ascertaining the installation angle between a roadway on which a vehicle travels and a detection direction of a measurement or radar sensor.

This object is achieved by the subject of the independent claims.

In the present case, a method is proposed for ascertaining an installation angle between a roadway on which a vehicle travels and a detection direction of a measurement or radar sensor, wherein the method comprises the following steps:

reading a plurality of reflection signals, each of which represents a reflection signal which was reflected by a measurement or radar beam emitted by a transmission unit of the measurement or radar sensor and which was reflected at a respective different reflective portion of the vehicle, wherein the reflection signals contain movement information on a movement direction of the reflective portion of the vehicle at which the measurement or radar beam was reflected, and/or wherein the reflection signals contain position information which represents the position of the reflective portion of the vehicle at which the measurement or radar beam was reflected;
detecting a movement direction component of the movement directions of the reflective portions of the vehicle, represented by the movement information, from the plurality of reflection signals, for which all reflective portions of the vehicle execute a similar movement, and/or
   a movement direction component for which the positions of the reflective portions of the vehicle, represented by the position information, are depicted at a same point in time, on the assumption of a movement according to the movement direction component, and at said point in time in a two-dimensional depiction form a shape having the greatest similarity to an L shape; and
   determining the installation angle using the detected movement direction component.

The term “movement direction component” may for example mean a movement vector having a component which, for example after vector breakdown, corresponds to the movement direction of a reflective portion of the vehicle. A position of the reflective portions of the vehicle may mean a geographical or relative position of the corresponding reflective portion of the vehicle in relation to the measurement or radar sensor. A greatest similarity may mean a dimension which characterizes the deviation of the shape, formed by the positions of the reflective portions at the same point in time, from the L shape. For example, for determining the greatest similarity, a standard deviation of the corresponding positions of the reflective portion at the same point in time from the longer or the shorter portion of the L shape may be determined.

The concept proposed here is based on the knowledge that the plurality of reflection signals is analyzed in that, for example in several (iteration) cycles, different movement direction components are assumed and the movement directions of the reflective portions of the vehicle are broken down using these assumed movement direction components. Here, it can then be established that a specific one of the assumed movement direction components can be extracted which is the same for all reflective portions of the vehicle, so that this movement direction component can then be interpreted for example as the direction of travel or travel speed of the vehicle, since all reflective portions of the vehicle must be directly connected to the vehicle and hence must have a movement in the direction of the movement direction component. Alternatively or additionally, the movement direction component may also be detected by back-calculating the reflection signals obtained at different points in time or the position information contained therein. This may also utilize the fact that, for different assumed movement direction components, in back-calculating the positions to a same point in time, the most probable movement direction component is the one in which a smallest deviation exists between one or more components of an L shape and the two-dimensional depiction of the positions back-calculated to the same point in time. The L shape may here be assumed to be representative of the shape of the vehicle when viewed by the measurement or radar sensor, in which the longer side (as a first component) of the L shape corresponds to a vehicle long side, and the shorter side (as a second component) of the L shape corresponds to the front or the rear of the vehicle. If however, when back-calculating the positions to the same point in time, a movement direction component is used which significantly deviates from the actual movement direction component of the reflective portions of the vehicle, when back-calculating the positions to the same point in time this will lead to a “blurring” of the shape formed by the back-calculated positions in the two-dimensional depiction, so that from this it can be established that the choice of the underlying movement direction component was not optimal.

The concept presented here offers the advantage that, with technically very simple implementation using pre-existing signals, the movement direction component of the vehicle can be detected or verified so that the installation angle can be determined in a technically very simple fashion, for example by means of known methods, using the movement direction component now detected. In this way, the complexity of installing a measurement or radar sensor as a measurement point for traffic infringements can firstly be significantly simplified, and furthermore the accuracy of the measurement results can be significantly improved.

An embodiment of the concept proposed here is advantageous in which in the step of detecting, the movement direction component is detected using a resolution process for an over-determined equation system and/or a Hough transformation. Such an embodiment offers the advantage of being able to use technically refined methods for detecting the movement direction component.

According to a further embodiment, in the step of detecting, the greatest similarity of shape can be detected by determining that movement direction component in which the positions of the reflective portions of the vehicle, which are represented by the position information, have the smallest standard deviation from one of the components of the L shape. Here for example, a standard deviation of the positions of the reflective portions of the vehicle, when back-calculated to the same point in time, in relation to the longer and/or shorter side as components of the L shape, can be determined. Such an embodiment offers the advantage of very rapid and precise detection of the most probable of several possible or assumed movement direction components, which is then used further as the detected movement direction component.

Furthermore, an embodiment of the concept proposed here is advantageous in which in the step of detecting, times of detection of the positions of the reflective portions of the vehicle, represented by the position information, are set in relation to the movement direction component, in order to obtain positions of the reflective portions at the same point in time. Such an embodiment of the concept proposed here offers the possibility of using different assumed movement direction components, and by using the points in time (which can also be regarded as a time stamp), determining a position of the reflective portions of the vehicle at a same point in time. In this way, a high accuracy can be achieved in detecting the most probable movement direction component with reflection signals which are often already available.

According to a further embodiment of the concept proposed here, in the step of detecting, the movement directions of the reflective portions, represented by the movement information, may be processed or interpreted as radial speed vectors of the reflective portions of the vehicle in order to detect the movement direction component. A radial speed vector may here mean a speed vector in the detection direction of the measurement or radar sensor. Such an embodiment of the concept proposed here offers the advantage that the signals from the measurement or radar sensor can be processed further as reflection signals without great loss of information.

An embodiment of the concept proposed here is particularly safe and reliable in which furthermore a step of tracking the vehicle is performed, in particular wherein the installation angle is furthermore determined iteratively using information on the tracked vehicle. Such an embodiment offers the advantage of providing a simple possibility of verification for the determined installation angle by means of a learning and relearning process which is easy to perform, so that the correspondingly obtained measurement results of such a signal processing can be considered very reliable.

Furthermore, an embodiment of the concept proposed here is advantageous in which

furthermore a step of statistical assessment of the probability of occurrence of positions of the reflective portions is performed in order to obtain the traffic lane of the vehicle, wherein the installation angle is determined using the obtained traffic lane. Such an embodiment can also offer a possibility of verification for the determined installation angle, so that the obtained measurement results of such a signal processing may also be regarded as very reliable.

Furthermore, the concept presented here creates a method for detecting a speed of a vehicle, wherein the method comprises the following steps:

ascertaining an installation angle between the roadway on which the vehicle travels and the detection direction of the measurement or radar sensor, according to a variant presented here; and _
detecting a speed of the vehicle using the ascertained installation angle.

With such an embodiment of the concept proposed here, advantageously the speed of the vehicle can be detected with high measurement accuracy, so that a speed detected in this way meets the requirements of legal acceptability of these measurement results.

The concept presented here furthermore creates a device which is configured to execute, actuate or implement the steps of a variant of a method presented here, using corresponding equipment. This embodiment variant of the invention in the form of a device also allows the object on which the invention is based to be achieved quickly and efficiently.

For this, the device may comprise at least one calculation unit for processing signals or data, at least one memory unit for storing signals or data, at least one interface to a sensor or an actuator for reading sensor signals from the sensor or for outputting data or control signals to the actuator, and/or at least one communication interface for reading or outputting data, which are embedded in a communication protocol. The calculation unit may for example be a signal processor, a microcontroller or similar, wherein the memory unit may be a flash memory, an EEPROM or a magnetic memory unit. The communication interface may be configured to read or output data wirelessly and/or by hardwired connection, wherein a communication interface which can read or output data via a hardwired connection can for example read these data electrically or optically from a corresponding data transmission line or output these into a corresponding data transmission line.

A device may in the present case mean an electrical device which processes sensor signals and outputs control and/or data signals depending thereon. The device may have an interface which may be configured by hardware and/or software. In a hardware configuration, the interfaces may for example be part of a so-called system ASIC which contains widely varying functions of the device. It is however also possible that the interfaces are separate integrated circuits or consist at least partially of discrete components. With a software configuration, the interfaces may be software modules which are present for example with other software modules on a microcontroller.

Also advantageous is a computer program product or computer program with programming code which may be stored on a machine-readable carrier or storage medium such as a semiconductor memory, a hard disk memory or an optical memory, and is used to execute, implement and/or actuate the steps of the method according to one of the embodiments described above, in particular if the program product or program is executed on a computer or a device.

Exemplary embodiments of the concept presented here are explained in more detail with reference to the following figures, wherein repeated description of the same or similar elements in the different figures is avoided, wherein these elements are designated by the same or similar reference signs. When a measurement or radar sensor is used, this may in particular also comprise optical sensors such as laser or light sensors of widely varying frequencies and bandwidths, which are not listed comprehensively for reasons of clarity and legibility. As an example and particularly preferably, the function method is depicted with reference to the radar sensor.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a diagrammatic top view of a scenario in which a vehicle speed is measured by means of a radar sensor using a device according to one exemplary embodiment;

FIG. 2 two diagrams illustrating detection of the optimal movement direction component;

FIG. 3 a diagram illustrating a reflection statistic for determining the positions of the reflective portions in relation to the radar sensor;

FIG. 4 illustrations explaining a detection of the movement direction component by analysis of object contours; and

FIG. 5 a flow diagram of a method according to one exemplary embodiment.

### DETAILED DESCRIPTION

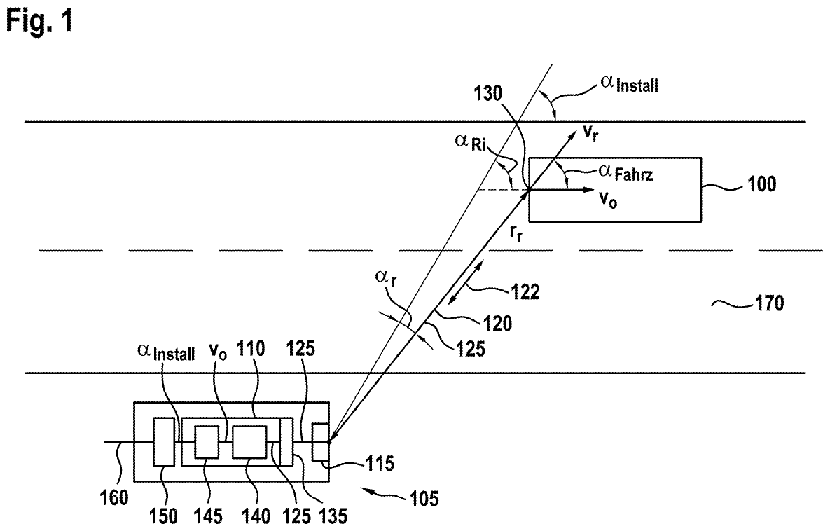

FIG. 1 shows a diagrammatic top view of a scenario in which the speed of a vehicle 100 is measured by means of a radar sensor 105 using a device 110 according to one exemplary embodiment. The radar sensor 105 here comprises a transmission and reception module 115 for emitting a plurality of radar beams 120 in a transmission (because of the shorter runtime of the radar beams 120) or a detection direction 122, and for receiving reflection signals 125 from the detection direction 122, wherein the reflection signals 125 each correspond to a radar signal 120 reflected at a reflective portion 130 of the vehicle 100. For greater clarity, FIG. 1 shows only the transmission and reception of a single radar signal 120 and the corresponding reflection signal 125, wherein evidently the illustration also describes the conditions for the transmission of several radar signals 120 and the reception and of several reflection signals 125.

From the transmission and reception module 115, the reflection signals 125 are read into the device 110 via a read-in interface 135 for determining an installation angle α_{Install} between a roadway on which a vehicle 100 travels and a detection direction 122, and transmitted to a device 140 for detecting the movement direction component v₀. In the device 140 for detecting the movement direction component v₀, in a procedure to be described in more detail below, the movement direction component v₀ is determined from the reflection signals and transmitted to a device 145 for determining the installation angle α_{Install}.

The installation angle α_{Install} ascertained in this way can now be processed further, for example in a device 150 for detecting a speed of the vehicle 100, in which a measurement value 160 corresponding to the speed of the vehicle 100 is determined which then corresponds with great accuracy to the speed of the vehicle 100 and can thus be used in a legally acceptable fashion for monitoring traffic incidents.

In order now to be able to determine the installation angle α_{Install}, it is necessary to determine firstly the movement of the vehicle 100 with the movement direction component v₀, since all reflective portions 130 of the vehicle 100 move with a same movement direction component v₀, and secondly also move the direction of the reflective portion 130 relative to the radar sensor 105 (i.e. the direction from which the reflection signal 125 is obtained) and/or to know the position of the reflective portion 130 relative to the radar sensor 105. Furthermore, an angle α_{Fahrz} between a movement direction of the vehicle 100 on a roadway 170 and the detection direction 122 may also be taken into account. In this way it is then possible, for example for reflection signals 125 recorded at different points in time and carrying corresponding time stamps or time information, to perform a corresponding back-calculation of the position of the reflective portions 130 to a same or identical point in time. In this way, it is possible to use also reflection signals 125 recorded spread over a longer time period, and thereby achieve the greatest possible precision of an obtained measurement result.

It is furthermore conceivable that the positions of the reflective portions 130 relative to the radar sensor 105, more precisely the transmission and reception unit 115, are detected and contained in the reflection signal 125 as corresponding position information. In this way for example, the positions of the reflective portions 130 of the vehicle 100 (for example using the distance rᵣ from FIG. 1) may have changed, wherein in this case a speed component vᵣ of the vehicle 100 in the direction of the detection direction 122 is also measured, which corresponds to a radial speed from the aspect of the radar sensor 105. For a very precise measurement result, a further angle α_{Ri} may also be taken into account, which is measured between the installation angle α_{Install} and the direction of the movement direction component v₀, so that also the deviation of the actual movement of the vehicle 100 from an orientation of the roadway 170 can be detected, wherein this deviation is usually not particularly large in comparison with other angles. The movement direction component v₀ may here be calculated approximately as follows using the variables given in FIG. 1:

$${v}_{o} = \frac{{v}_{r}}{cos ( {α}_{Fahrz} )} = \frac{{v}_{r}}{cos ( {α}_{Ri} + {α}_{r} )} \approx \frac{{v}_{r}}{cos ( {α}_{Install} + {α}_{r} )}$$

If now the movement direction component v₀ is known, the equation above may be resolved for example in relation to the installation angle α_{Install} in order to thereby obtain this value for the installation angle α_{Install}.

A more detailed description of the procedure for determining the measurement values is given below, wherein as a radar sensor 105, here for example a tracking radar system was used, in particular as an FSK radar. This can determine the position in x-y coordinates (or polar coordinates) and the relative speed vᵣ of individual reflectors or reflective portions 130. The relative speed vᵣ is the speed of a reflector or reflective portion 130 in relation to the radar sensor 105. The tracked objects (here the vehicles 100) of the radar sensor 105 are used to detect traffic infringements. For this, amongst others, for example the position, speed, size and movement direction of the objects or vehicles 100 are required. In particular, for detecting the precise speed v₀, as a movement direction component for penalizing speed infringements, the movement direction α_{Ri} of an object such as the vehicle 100 relative to the radar sensor 105 is an important variable, as shown in more detail in FIG. 1.

The movement direction or movement direction component v₀ of an individual object such as the vehicle 100 in the movement direction α_{Ri} is determined for example by means of tracking. Using the installation angle (also known as the twist angle α_{Install}, tracks can be initialized with an approximately correct movement direction. In this way, the actual movement direction or movement direction component v₀ can be detected sufficiently quickly or also over short distances, in order to determine object speeds v₀ with sufficient precision for speed infringements.

In other words, for the current tracking radar, precise knowledge of the installation angle α_{Install} is necessary in order to detect traffic infringements with sufficient speed accuracy. A common method of determining the installation angle α_{Install} is the setting of the housing of the radar sensor 105 relative to the road or roadway 170. Various aids (angle brackets, laser distance meter, imaging sensors (cameras) with known relation to the radar etc.) may be used. Depending on the technical structure of the entire measurement system, this approach may be inaccurate, difficult or impossible. If the radar is for example mounted in an external housing, it is only possible to align the external housing to the road or roadway 170. Here, the installation angle α_{Install} is dependent on the accuracy and stability of the construction. If the radar or the housing is installed in inaccessible locations (e.g. very high), calibration of the mechanical structure relative to the road 170 is hardly possible.

An alternative to calibration between the mechanical structure and the road 170 is the use of information supplied by the radar sensor 105. Thus for example in the FS3 learning tool, the tracks supplied by the radar sensor 105 are analyzed with respect to their movement direction in order to derive the installation angle α_{Install} therefrom. Since, because of the limited bandwidth, the radar sensor 105 can only supply a fraction of the information and the tracks supplied by the radar or radar sensor 105 may be defective, in some scenarios this approach may not provide sufficiently high accuracy for determining the installation angle α_{Install}.

If it is difficult or impossible to set up the radar 105 via the housing, use of an auto-setup of the radar (or synonymously, the radar sensor 105) is proposed. For this, the radar 105 uses internal information to learn the average movement direction v₀ of vehicles such as the vehicle 100 shown as an example in FIG. 1, and hence the installation angle α_{Install}. For this, various independent information or procedures may be used:

### Variant 1: Detecting the Installation Angle α_{Install} by Tracking

Self-propelled objects such as the vehicle 100 are initialized with an initial angle α_{Install} (e.g. 0°). By tracking the objects 100, the movement course (movement direction or movement direction component v₀) can be determined, and a differential angle from the initial angle for the installation angle α_{Install} can be established. The initial angle α_{Install} can be corrected by the difference. By repeating the process, the original initial installation angle α_{Install} can be brought ever closer to the actual installation angle α_{Install}.

Variant 2: Detecting the Installation Angle α_{Install} from the Object Speed as a Movement Direction Component v₀

It is assumed that all reflective portions 130 (synonymously, also reflectors) of a vehicle 100 move forward with the same speed and same direction. Because of the different observation angles α_{Fahrz} of the reflectors 130, the measured radial speeds vᵣ of the reflectors 130 differ. On the above assumption, a common movement direction in which all reflectors 130 have the same speed can be determined as the movement direction component v₀. This movement direction component v₀ corresponds to the installation angle α_{Install}. This problem (i.e. finding the optimal movement direction component v₀) may be solved with widely varying methods. For example, the solution of an over-determined equation system or a Hough transformation may be suitable.

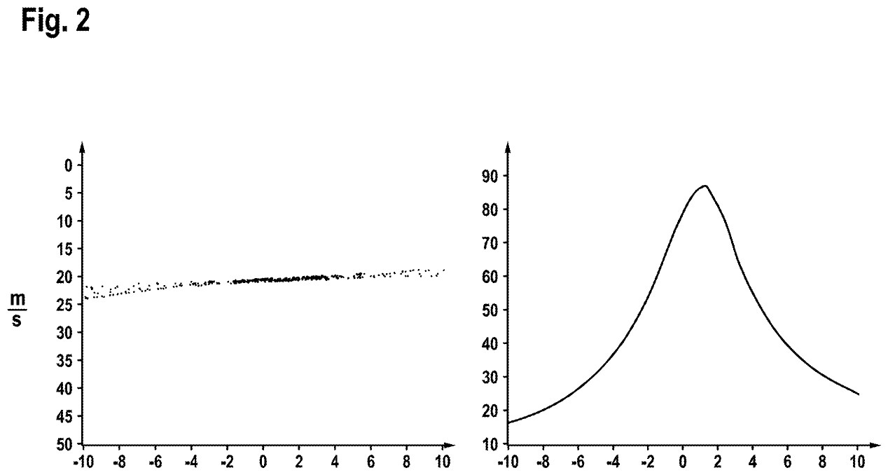

FIG. 2 shows two diagrams depicting the detection of the optimal movement direction component v₀. Here, in the left-hand diagram, the abscissa shows a hypothetical movement direction or movement direction component v₀ which deviates from a reference value 0 (arranged centrally on the abscissa) within a tolerance range of for example 10 m/s. The ordinate of the left-hand diagram shows the hypothetical vehicle speed in m/s.

The right-hand part diagram from FIG. 2 depicts an accumulation amplitude indicating how many measurement values of the plurality of measurement values of the radar sensor 105 (shown on the ordinate) were obtained for the respective hypothetical movement direction component v₀ (shown on the abscissa).

Here, it is evident from the right-hand diagram in FIG. 2 that the greatest number of measurement values, for a hypothetical movement direction component v₀, occurs at a value just to the right of the reference value. This also correlates with a result from the left-hand diagram, which also shows that the greatest frequency occurs at a value just to the right of the reference value, namely at a hypothetical vehicle speed of 20 m/s, which is then also detected as the value of the movement direction component v₀.

### Variant 3: Detecting the (Installation) Angle α_{Install} by Reflection Statistics

By accumulating in a 2D map the unprocessed targets or the positions of the reflective portions 130 detected as position information, the probability of occurrence of positions of the unprocessed targets as the reflective portions 130 in the world can be determined.

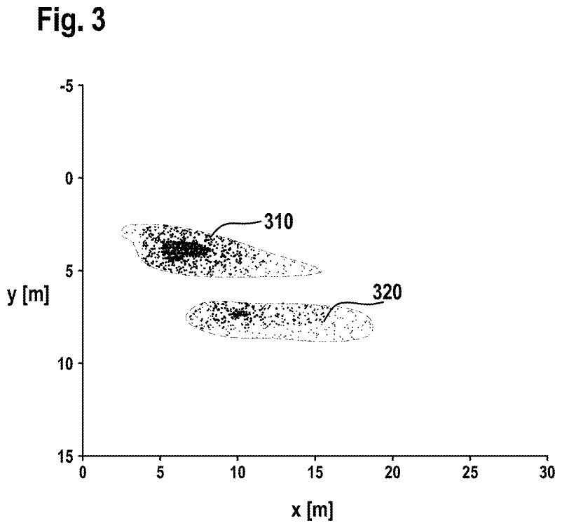

FIG. 3 shows a diagram illustrating a reflection statistic for determining the positions of the reflective portions 130 relative to the radar sensor 105. Here, the abscissa shows a coordinate of the relative position of the reflective portion 130 in the x direction relative to the radar sensor 105, and the ordinate shows a coordinate of the relative position of the reflective portion 130 in the y direction relative to the radar sensor 105. It is again evident that in the diagram, two point clouds 310 and 320 occur which represent those positions at which many reflective portions 130 of the vehicle 100 were found. From this, the traffic lanes and their courses and hence the installation angle α_{Install} can be derived.

### Variant 4: Detecting the (Installation) Angle α_{Install} by Object Contours

When a vehicle 100 passes the radar 105, typically parts of the vehicle side and the vehicle front/rear are visible. The determined vehicle speed v₀ can be used to project all measured reflections onto a point in time.

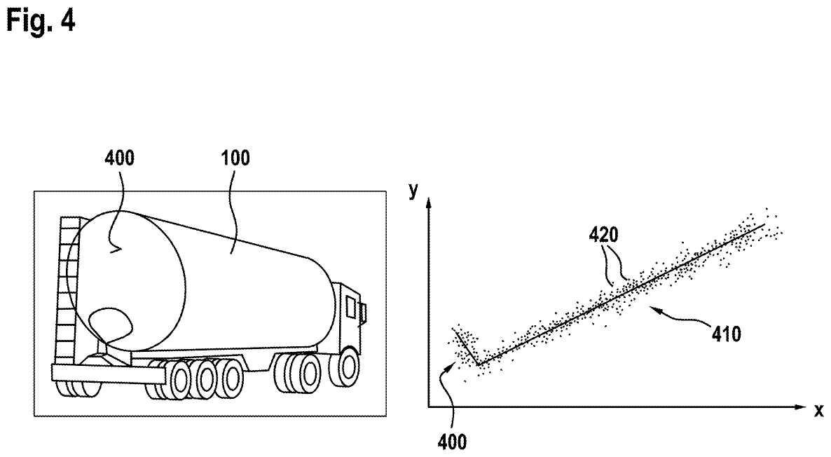

FIG. 4 shows depictions explaining a detection of the movement direction component v₀ by analysis of object contours. Here, a left-hand depiction shows an image of a truck as a vehicle 100, as the vehicle appears from the rear. Thus the long side is evident as the longer side of the vehicle 100 as a truck, and the rear side of the truck 400 as the shorter side. If now the radar sensor 105 emits radar beams 120 onto the vehicle 100, and the reflection signals 125 reflected back by the different reflective portions 130 are analyzed with respect to the positions at which the reflective portions 130 are situated relative to the radar sensor 105, then in a two-dimensional depiction, a shape of the positions 420 represented by the reflection signals 125 can be obtained, which corresponds to an L shape 410 as shown in the right-hand diagram of FIG. 4. The result of such a depiction of the positions 420 of the reflective portions 130 is thus a typical L shape 410 (front/rear and side). Depending on which movement direction component v₀ of the vehicle 100 is assumed, the L shape 410 is sharper or more diffuse. Thus the movement direction component v₀ of the object or vehicle 100 and hence the installation angle α_{Install} can be determined by selecting the optimal angle at which the projection or the form shown by the two-dimensional depiction of the positions of the reflective portions 130 is as sharp as possible, so that this shape obtained by the projection has the greatest similarity or the smallest deviation from the L shape. Mathematically, such a greatest similarity or smallest deviation may for example be determined when, for this movement direction component v₀, the standard deviation of the side part and the front/rear part of the projected positions relative to components such as the longer or shorter bars of the L of the L shape is as small as possible.

For learning the installation angle α_{Install}, one of the proposed methods or the combination of several methods may be used. To increase the stability of determination of the installation angle α_{Install}, the movement direction component v₀ of several vehicles 100 may be detected and combined. In this way, the analysis of the reflection signals 125 for several reflective portions 130 on several vehicles 100 may lead to an increase in precision of the measurement values obtained by the radar sensor 105 in subsequent measurement operation.

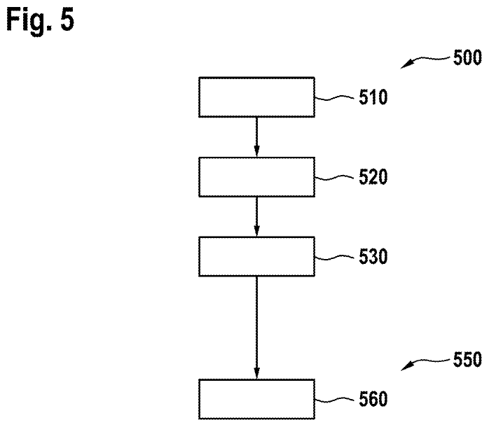

FIG. 5 shows a flow diagram of a method 500 for determining the installation angle α_{Install} between a roadway on which a vehicle travels and a detection direction of a radar sensor. The method 500 comprises a step 510 of reading, a step 520 of detecting, and a step 530 of determining. In the step 510 of reading, a plurality of reflection signals are read, which each represent a reflection signal which was reflected by a radar beam emitted by a transmission unit of the radar sensor and which was reflected at a respective different reflective portion of the vehicle, wherein the reflection signals contain movement information on a movement direction of the reflective portion of the vehicle at which the radar beam was reflected, and/or wherein the reflection signals contain position information which represents the position of the reflective portion of the vehicle at which the radar beam was reflected. In the step 520 of detecting, a movement direction component of the movement directions of the reflective portions of the vehicle, represented by the movement information, from the plurality of reflection signals is detected, for which all reflective portions of the vehicle execute a similar movement. Alternatively or additionally, a movement direction component may be detected in which positions of the reflective portions of the vehicle, represented by the position information, are depicted at a same point in time, on the assumption of the movement corresponding to the movement direction component, and at this point in time in a two-dimensional depiction form a shape which has the greatest similarity to an L shape. In the step 530 of determining, the installation angle is determined using the detected movement direction component.

FIG. 5 furthermore shows a method 550 for detecting a speed of the vehicle 100, wherein the method 550 comprises the steps of the method 500 and a step 560 of detecting the speed of the vehicle 100 using the ascertained installation angle α_{Install}.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for ascertaining an installation angle between a roadway on which a vehicle travels and a detection direction of a measurement or radar sensor, wherein the method comprises the following steps:
reading a plurality of reflection signals, each of which represents a reflection signal which was reflected by a measurement or radar beam emitted by a transmission unit of the measurement or radar sensor and which was reflected at a respective different reflective portion of the vehicle, wherein the reflection signals contain movement information on a movement direction of the reflective portion of the vehicle at which the measurement or radar beam was reflected, and/or wherein the reflection signals contain position information which represents the position of the reflective portion of the vehicle at which the measurement or radar beam was reflected;
detecting a movement direction component of the movement directions of the reflective portions of the vehicle, represented by the movement information, from the plurality of reflection signals, for which all reflective portions of the vehicle execute a similar movement, and/or
a movement direction component for which positions of the reflective portions of the vehicle, represented by the position information, are depicted at a same point in time, on the assumption of a movement according to the movement direction component, and at said point in time in a two-dimensional depiction form a shape having the greatest similarity to an L shape; and
determining the installation angle using the detected movement direction component.

2. The method as claimed in claim 1, wherein in the step of detecting, the movement direction component is detected using a resolution process for an over-determined equation system and/or a Hough transformation.

3. The method as claimed in claim 1, wherein in the step of detecting, the greatest similarity of shape is detected by determining that movement direction component in which positions of the reflective portions of the vehicle, which are represented by the position information, have the smallest standard deviation from one of the components of the L shape.

4. The method as claimed in claim 1, wherein in the step of detecting, times of detection of the positions of the reflective portions of the vehicle, represented by the position information, are set in relation to the movement direction component in order to obtain positions of the reflective portions at the same point in time.

5. The method as claimed in claim 1, wherein in the step of detecting, the movement directions of the reflective portions, represented by the movement information, are processed or interpreted as radial speed vectors of the reflective portions of the vehicle in order to detect the movement direction component.

6. The method as claimed in claim 1, wherein furthermore a step of tracking the vehicle is performed, in particular wherein the installation angle is furthermore determined iteratively using information on the tracked vehicle.

7. The method as claimed in claim 1, wherein furthermore a step of statistical assessment of the probability of occurrence of positions of the reflective portions is performed, in order to obtain the traffic lane of the vehicle, wherein the installation angle is determined using the obtained traffic lane.

8. A method for detecting a speed of a vehicle, wherein the method comprises the following steps:
ascertaining an installation angle between the roadway on which the vehicle travels and the detection direction of the measurement or radar sensor, according to a method of the preceding claims; and
detecting a speed of the vehicle using the ascertained installation angle.

9. A device with equipment, which is configured to execute, implement and/or actuate the steps of a method as claimed in claim 1.

10. A computer program with programming code, which is configured to actuate, execute and/or implement the steps of the method as claimed in claim 1.

11. A machine-readable storage medium on which a computer program as claimed in claim 10 is stored.
